(19) United States
(12) Patent Application Publication
(10) Pub. No.: US 2013/0243916 A1
(43) Pub. Date: Sep. 19, 2013

(54) LOW SODIUM SALT TORTILLA AND METHOD FOR PREPARATION THEREOF

(71) Applicants: Stephen Charles Bright, Fenton, MO (US); Mattheus Antonius Jozef van der Lee, Maasland (NL); Martinus Gerardus van Oort, Utrecht (NL)

(72) Inventors: Stephen Charles Bright, Fenton, MO (US); Mattheus Antonius Jozef van der Lee, Maasland (NL); Martinus Gerardus van Oort, Utrecht (NL)

(73) Assignee: Bakery Technology Center B.V., Wagenberg (NL)

(21) Appl. No.: 13/821,859

(22) PCT Filed: Sep. 10, 2010
(86) PCT No.: PCT/NL2010/050577

§ 371 Date: May 17, 2013

(51) Int. Cl. A21D 2/02; A23L 1/237

(52) U.S. Cl. CPC A21D 2/02; A23L 1/237
USPC 426/296; 426/560

(57) ABSTRACT

The invention includes a flour tortilla having a low sodium content and to a method for preparing same. The method comprises has the following steps: (i) providing a flour tortilla dough in a portion sufficient to prepare the tortilla; (ii) coating at least part of the surface of the dough with a salty taste enhancer, thus obtaining a coated dough; thereafter (iii) forming the coated dough into a tortilla shape; and thereafter (iv) baking the coated dough. The salty taste enhancer is a sodium salt substitute or the salty taste enhancer is a sodium salt composition having enhanced salty taste, or the salty taste enhancer is a chloride salt of sodium or potassium, applied in an amount of at least 0.05 wt. % based on flour weight.

The invention is directed to a method for preparing a flour tortilla and to a flour tortilla.

Flour tortillas are a baked product, made from cereal flour, usually maize or wheat.

Wheat flour tortillas are gluten structured, just like bread. Almost all tortillas are chemically leavened, baked quickly and cooled to ambient temperatures in less than 15 minutes.

Flour tortillas have soft, silky, smooth texture, are opaque and fluffy and have excellent pliability; are resistant to cracking and have small, evenly distributed blisters. Blisters create desirable characteristics in the final product, showing up as lightly browned spots on the surface.

Flour tortillas can be made by making a dough from flour, fat, sodium chloride and water.

The consumption of sodium chloride (table salt) has long been suspected as a cause of health problems, particularly high blood pressure (hypertension). The deleterious effects of table salt are primarily caused by the sodium content thereof.

In recent years much attention has been given to the desirability of reducing the dietary intake of sodium. Although sodium chloride is a natural component of many food products, it is widely used as a supplement in processed foods for flavor and preservative effects and as a condiment in preparing foods. Upon consumption, sodium chloride is perceived as having a direct and intense salty impact, which impact is followed by a milder lingering salty taste.

Due to the high level of salt which is usually present in many baked products, the baking industry is often seen as a preferred target for salt reduction. However, apart from being an important flavour compound, salt is also a very relevant functional ingredient. This means that salt reduction in baked products needs to be investigated carefully.

One way of lowering high sodium levels in foods is by simply lowering the level of sodium salt added to the food. However, this is often not an adequate solution, because it results in a reduced salt perception and is therefore undesired.

As an alternative to lowering the sodium content in products, a variety of sodium-free and low sodium compositions have been proposed which contain additives to improve and/or mimic the flavor of sodium chloride. These additives may be used to replace all or a part of the sodium chloride present in conventional salty food products. Such additives may roughly be divided into sodium salt (compositions) having enhanced salty taste and sodium salt substitutes.

An example of a sodium salt composition having enhanced salty taste can be found in WO 2009/133409, which describes a method for preparing a salt product comprising atomizing a mixture comprising salt dissolved in a solvent, which mixture further comprises an organic material that is solid under ambient temperature conditions. The organic material is for instance a polysaccharide, such as gum arabic, maltodextrin, guar gum, carrageenan, hydroxypropyl cellulose and agar agar. The salt product has enhanced “saltiness” as compared to conventional salt and may be used in much lower amounts in food whilst still providing the same taste level.

An example of sodium salt substitutes is given in WO-A-2008/068155, which describes a method for preparing a cereal product having a reduced sodium content from a flour-based and sodium-containing dough using an autolyzed yeast as a replacement for part of the sodium in the dough. In this method, the autolyzed yeast is mixed into the dough together with the other ingredients.

A disadvantage of this method is that still a relatively high amount of sodium salt (sodium chloride) is used to obtain a desirable salt perception.

Another example of a sodium salt substitute is potassium chloride.

Frequently found disadvantages of sodium salt substitutes (including potassium chloride) as a replacement in tortilla dough is that they add an additional off-taste to the product or either lack the salty impact or lingering salty taste of sodium chloride.

It is in particular challenging to reduce the sodium content in flour tortillas, while at the same time maintaining a good taste. Reduction of sodium salt (i.e. sodium chloride) in flour tortillas usually results in a bland taste. This is primarily thought to be due to the fact that tortillas are chemically leavened and do not undergo fermentation. Most cereal dough products, such as bread, are fermented during the preparation process. The fermentation process typically adds complex organic flavors that boost the perceived savory notes, which contributes to obtaining a tasteful product. The absence of a fermentation step in flour tortilla preparation thus poses an additional challenge when trying to obtain a tasteful low sodium flour tortilla.

It is an object of the invention to provide a novel method for preparing tortillas, wherein a relative small amount of flavour compounds need to be used to obtain a tortilla with good taste.

It is an object of the invention to provide a novel method for preparing tortillas, in particular tortillas with a relatively low sodium content.

It is a further object of the invention to provide a method for preparing a flour tortilla, in particular a flour tortilla having a relatively low sodium content, which flour tortilla has an intense salt sensation upon consumption and/or a lingering salty taste.

It is a further object to provide a method for preparing a flour tortilla having a low sodium content, wherein the tortilla has one or more additional desirable properties, in particular with respect to at least one property selected from the group of folding characteristics, breaking characteristics, rolling characteristics, springiness, crust colour, layering/puffing, opacity, stacking stickiness and stack height.

At least one of these objects has been met by providing a method for preparing a flour tortilla comprising
providing a flour tortilla dough in a portion sufficient to prepare the tortilla;
coating at least part of the surface of the dough with a flavoring, in particular with a salty taste enhancer, thus obtaining a coated dough; thereafter
forming the coated dough into a tortilla shape; and thereafter
baking the coated dough;
   wherein the salty taste enhancer is a sodium salt substitute, or
   wherein the salty taste enhancer is a sodium salt composition having enhanced salty taste, or
   wherein the salty taste enhancer is a chloride salt of sodium or potassium, which chloride salt is applied in an amount of at least 0.05 wt % based on the total weight of flour used in the dough (flour weight).

The inventors realized that applying a flavoring on a tortilla according to the method of the invention enhances the taste of the tortilla. Preferably, a salty taste enhancer is used as the flavoring in the method of the invention.

The inventors realized that the salty sensation has been significantly higher when a salty taste enhancer is present at the surface of the tortilla compared to when the salty taste enhancer is homogeneously distributed within the entire volume of the tortilla. It is expected that the intensity of flavor of the sodium salt or salt substitute is enhanced due to surface concentration and immediate availability of the salty taste enhancer for taste receptors in the mouth.

It has surprisingly been found that by coating the surface of the flour tortilla dough with a salty taste enhancer, a more intense salt sensation is perceived compared to when the salty taste enhancer is present mixed through the dough. In particular, the initial salty taste of the flower tortilla is enhanced and the initial salty taste is followed by a lingering salt sensation.

It has further surprisingly been found that by coating the surface of the flour tortilla dough with a salty taste enhancer in combination with a food acid, an even more intense salt sensation is perceived. It is expected that the combination of a salty taste enhancer and a food acid has a synergistic effect on the salt sensation.

The method of the invention has a further advantage in that it allows for using a dough that is more easily relaxed and less elastic compared to conventional dough used in the tortilla preparing methods known in the art. To obtain a tortilla that has a sufficiently salty taste, sodium salt, in particular sodium chloride, is added and mixed through conventional tortilla dough. However, it is contemplated that the presence of sodium chloride in the dough may influence the behavior of gluten that may be present in the dough, which negatively affects the relaxation of the dough. Since gluten network formation is less relevant in tortillas than e.g. in bread making, reduction of the amount of sodium chloride is very well possible from a functional point of view. However, also in tortillas there is a minimum amount of salt needed for optimal dough characteristics. The method of the invention thus allows for a reduced amount of sodium chloride in the dough, such that a dough is obtained having better properties regarding relaxation and elasticity. A dough with a reduced amount of sodium chloride is more easily relaxed and can therefore be more easily handled. Consequently, obtaining a baked product with the method of the invention generally requires less effort, in particular with respect to pressing the dough, in which the size and shape of the dough are critical.

Preferably, the coating step of the method of the invention further includes coating at least part of the surface of the dough with a fatty substance. It has been surprisingly found that the combination of fatty substance and salty taste enhancer provides for an extended lingering salt sensation. Without wishing to be bound by any theory, it is expected that the fatty substance carries the flavor of the salty taste enhancer longer as the fatty substance melts in the mouth. Furthermore, the salty taste enhancer may be more homogeneously distributed by a coating step with fatty substance, because the fatty substance may contribute to an even distribution of the salty taste enhancer when the fatty substance melts during the step of shaping the tortilla.

The term “salty taste enhancer” refers to a compound or composition that provides a food product with a salty taste.

By applying the salty taste enhancer to the surface of the dough before baking, the salty taste of the tortilla is improved. Thus, it is possible to reduce the sodium content of the food product without adversely affecting its taste.

A salty taste enhancer other than sodium salts may be used to replace sodium salt in food products without substantially affecting the salty taste of the product. Thus, it is possible to reduce the sodium content of the food product without adversely affecting its taste.

A sodium salt substitute is a compound or composition capable of imparting a food product with a salty taste similar to a sodium salt (in particular sodium chloride), wherein no sodium or less sodium is required to impart the same salty taste intensity.

The term “sodium salt composition having enhanced salty taste” refers to a composition comprising a sodium salt, which has a stronger salty taste per mole of sodium compared to sodium chloride. The composition may be one compound or a combination of compounds.

The term “sodium salt” as used herein may refer to any sodium salt that may be used in food products, such as sodium chloride, sodium glutamate, sodium propionate and sodium acetate.

Examples of sodium salt substitutes are potassium salts (applied in an amount of at least 0.05 wt. % based on flour weight), glutamates (in particular glutamates other than sodium glutamates), processed yeasts, such as yeast extracts (e.g. autolyzed yeast and hydrolyzed yeast), dried yeast and inactivated yeast, protein hydrolysates, such as hydrolyzed vegetable proteins (HVPs) and enzymatically hydrolyzed vegetable proteins (EHVPs) and 5′nucleotides. Processed yeast has in particular been found to be a very suitable sodium salt substitute in accordance with the present invention. It has been found that the use of tortilla dough coated with both processed yeast and a fatty substance according to the method of the invention results in a baked flour tortilla having an enhanced salty taste. It has further been found that compared to other salty taste enhancers, in particular compared to sodium salt compositions having enhanced salty taste, a small amount of processed yeast is sufficient for this enhanced salty taste. Thus, processed yeast used according to the invention provides for a very potent sodium salt substitute.

Furthermore, it has been found that the use of processed yeast in the method of the invention may provide the obtained baked product with additional savory flavor notes besides the salty taste. Thus, the use of processed yeast may overcome the problem of the bland taste encountered in low salt tortillas.

Furthermore, it has been found that the presence of processed yeast at the surface of the dough may contribute to the desirable formation of blisters during baking. Blisters are lightly browned spots on the surface, which are appreciated by many consumers. Furthermore, blisters provide the tortilla with desirable properties such as browning and caramelization and may further enhance or intensify the savoury notes. The presence of processed yeast at the surface of the dough may increase in blister formation during baking compared to similar methods wherein no processed yeast is used.

Processed yeast as used in the application may refer to yeast which has been subjected to a chemical treatment, such as drying, extraction or an inactivation treatment. Examples of process yeast are autolyzed yeast, yeast extract, dried yeast, hydrolyzed yeast and inactivated yeast. The reason that yeast should first be subjected to a chemical treatment is that ‘regular’ yeast does not have a suitable flavor to use it as a salty taste enhancer. Furthermore, ‘regular’ yeast has a higher risk for contamination compared to processed yeast. The processed yeast used in the invention may be selected from the group consisting of yeast extract, such as autolyzed yeast and hydrolyzed yeast, dried yeast and inactivated yeast.

Autolyzed yeast is the common name for various forms of processed yeast products prepared by extracting the cell contents of yeast. In case the cell walls of the yeast are removed during extraction, autolyzed product may be called autolyzed yeast extract. Autolyzed yeast may comprise glutamate.

According to the invention, the autolyzed yeasts may be obtained from any yeast, in particular from a yeast strain that belongs to the genera Saccharomyces, Kluyveromyces or Candida.

A further example of a sodium salt substitute is a glutamate salt other than sodium glutamate. Glutamate salts have a savory extending or rounding sensation, known in Japan as Umami. Some types of processed yeasts, such as yeast extracts and autolyzed yeast, as well as hydrolyzed vegetable proteins and enzyme hydrolyzed vegetable proteins may comprise glutamates.

An example of a sodium salt composition having enhanced salty taste is micro-crystalline sodium chloride, such as a micronized or atomized powder of sodium chloride. Micro-crystalline sodium chloride has enhanced salty taste due to the increased surface area of sodium chloride particles compared to regular sodium chloride crystals. A composition comprising a micro-crystalline sodium chloride may further comprise a compound that provides the composition with the capability to remain free-flowing. Such a compound does typically not have a taste, such as a salty taste, by itself. In such a case, the compound is said to be taste neutral. The compound providing the composition with its free-flowing property is typically free of sodium.

A further example of a sodium salt composition having enhanced salty taste is a salt product comprised of composite particles comprising salt (such as sodium chloride) and an organic material. Such a salt product may for example be obtained by atomizing a mixture comprising salt dissolved in a solvent, which mixture further comprises an organic material that is solid under ambient temperature conditions. The organic material may be a compound that provides the salt product to remain free-flowing at ambient conditions (e.g. in bags or other containers and/or at room temperature, with a relative humidity of 60%-80%) for a long time, such as time periods longer than 18 months. The inert material does typically not have a taste, such as a salty taste, by itself. In such a case, the inert material is said to be taste neutral. The inert material is typically free of sodium. The organic material is for instance a polysaccharide, such as gum arabic, maltodextrin, guar gum, carrageenan, hydroxypropyl cellulose and agar agar. Suitable sodium salt compositions having enhanced salty taste are described in WO 2009/133409, which document is hereby incorporated by reference, in particular on pages 3 and 4, second and third paragraph of WO 2009/133409.

A further example of a sodium salt composition having enhanced salty taste is monosodium glutamate (MS). Monosodium glutamate (MSG) is a sodium salt of glutamate. Although monosodium glutamate comprises sodium, it may under certain circumstances have an increased salty taste compared to sodium chloride MSG has a negative connotation in the US due to debates regarding the safety of MSG and may therefore not be a preferred ingredient in tortillas directed to the US market.

The salty taste enhancer may also be sodium chloride or potassium chloride, applied to the at least part of the surface of the dough in an amount of at least 0.05 wt. %, based on flour weight , for example at least 0.1 wt. % or at least 0.15 wt. %.

Although the content of sodium chloride in the flour tortillas obtained with the method of the invention should be kept as low as possible, it may in some cases be preferred to use sodium chloride. Reason for this is that at least a certain amount of sodium chloride is needed to obtain a suitable salty taste. Furthermore, it was found that coating the dough with sodium chloride instead of mixing sodium chloride through the dough increases the salty sensation of the baked tortilla. The amount of sodium chloride with which the dough is coated may be 0.03-1.0 wt. %, more preferably 0.5-0.7 wt%, or most preferably 0.1 -0.3 wt% based on flour weight.

In addition to the salty taste enhancer, the at least part of the surface of the dough may further be coated with additional ingredients (before baking the dough). Such ingredients are referred to as coating ingredients. Examples of coating ingredients are fatty substances, food acids, ammonium salts, sodium chloride and potassium chloride.

The amount of salty taste enhancer coated on the at least part of the surface of the dough in the method of the invention may be 0.05-1 wt. %, preferably 0.1-0.7, more preferably 0.2-0.4 wt. % based on flour weight.

The method of the invention may comprise a coating step comprising coating at least part of the surface of the dough with a fatty substance and a salty taste enhancer, thus obtaining a coated dough. As described above, the fatty substance may have a desirable effect on the salty taste of the tortilla. A method for preparing a tortilla wherein the tortilla dough is coated with a fatty substance is known from WO 2009/041821.

As a fatty substance, in principle any fat, lipid or emulsifier (which generally comprises a hydrophobic group, e.g. a fatty acid group, a hydrocarbon group or a group having a similar or higher hydrophobicity) may be used that is allowed to be used in a food application.

Preferably, the fatty substance is a solid at room temperature while being liquid during the shaping step, when typically increased temperatures a used (for example when a heated press is used). Consequently, the fatty substance preferably has a melting point between 40 and 60° C., more preferably between 35 and 50° C. This advantageous, because the solid fatty substance on the surface will then melt during the pressing of the tortilla, and can then homogeneously spread over the surface of the tortilla. It is expected that the other coating ingredients, such as the salty taste enhancers, will spread with the fat in the same homogeneous way. The homogeneous spreading of the fat and other coating ingredients over the tortilla surface is expected to contribute to the beneficial taste sensation of the tortillas obtained with the method of the invention.

The coating step may further comprise coating at least part of the surface of the dough with a food acid. Any food acid known in the art may be used for this purpose. For example, the food acid may be selected from the group consisting of acetic acid, citric acid, tartaric acid, malic acid, fumaric acid and lactic acid. Acetic acid may for example be applied in the form of vinegar. It has surprisingly been found that by coating at least part of the surface of the flour tortilla dough with both a salty taste enhancer and a food acid, an even more intense salt sensation is perceived compared to coating the dough with only the salty taste enhancer. It is expected that the combination of a salty taste enhancer and a food acid may have a synergistic effect on the salt sensation

The coating step may further comprise coating at least part of the surface of the dough with ammonium salt. It has been found that the presence of ammonium salts at the surface of the tortilla dough may improve surface browning of the flour tortilla during the baking step. This is desirable, because the occurrence of browning may be have a positive effect on the savoury notes due to the Maillard Browning Reactions. Thus, the addition of ammonium salts to the surface of the tortilla dough may provide the baked product with extra flavour. This may for example reduce the bland taste frequently observed in low sodium tortillas. Furthermore, ammonium salts, in particular ammonium sulphate and ammonium chloride, may lower the surface pH of the baked tortilla, which is advantageous with regard to lowering microbial activity, which can lead to early spoilage, in particular when the ammonium salts are used in conjunction with preservatives.

The coating step may further comprise coating at least part of the surface of the dough with sodium chloride.

The compounds applied to the dough in the coating step, i.e. the fatty substance, salty taste enhancer and optionally other compounds, may be referred to as the coating ingredients. Preferably, the coating ingredients are solids at room temperature. The coating ingredients may be applied in any way. For example, the coating ingredients may be applied to the surface of the dough by scattering, sprinkling, strawing, or other methods known in the art for covering a fine powder to the surface of food products.

The coating ingredients are preferably applied to the at least part of the surface of the dough in one step. For this purpose, the coating ingredients may first be mixed to obtain a coating ingredient mixture before applying to the dough surface. Preferably, the coating ingredients are mixed to form a dry, free flowing powder with particle size preferably between 20 and 200 micron, more preferably between 50 and 150 micron and most preferably between 70 and 110 micron. Furthermore, preferably all ingredients in the coating ingredient mixture have essentially the same particle size. In particular, the coating ingredient mixture may have an average particle size of around 70 micron with a standard deviation of 20 micron. Such particle size (distribution) is preferred in order to provide the mixture with desirable free flowing properties and as little as possible lump formation or caking.

The coating ingredients may also be applied to (part of) the surface of the dough in more than one step. Thus, it is not important to first prepare one coating composition comprising all coating ingredients before applying it to the dough surface. The sequence of applying the different coating ingredients is not vital, as long as all coating composition ingredients are applied to part of the dough surface prior to the baking step. For example, the fatty substance may be applied first to the dough surface, then formed into a tortilla shape, after which the sodium salt substitute may be sprinkled at the dough surface covered with fatty substance, and subsequently baked.

A tortilla prepared by the method of the invention has enhanced salty taste. The sodium chloride used in conventional flour tortilla dough may thus be reduced. Accordingly, the dough used in the method of the invention may have a sodium chloride content less than 1.5 wt. %, preferably less than 1 wt. %, even more preferably less than 0.7 wt. %, based on the total flour weight.

As described hereinabove, sodium chloride may also be one of the coating ingredients. Preferably, the coated dough has a sodium chloride content less than 1.3 wt. %, more preferably less than 1.1 wt. %, based on the flour weight. A coated dough comprises both the ingredients applied to the surface of the dough (coating ingredients) and the ingredients from which the dough is prepared prior to coating (dough ingredients).

The fatty substance used in the coating step may be provided on a carrier, for instance (wheat) starch or flour. Preferably, the fatty substance is used in combination with a drying agent. The drying agent has a drying effect at the surface of the dough. As a drying agent, in general hygroscopic substances, suitable for use in a food application, can be used. In particular, the drying agent may be selected from (wheat) flours and hygroscopic salts, such as a chloride or sulphate salt of potassium, magnesium or calcium.

In particular, the fatty substances may be selected from (triglyceride) oils, fat flours, emulsifiers, hardened fats, shortenings, emulsified shortenings, waxes, lecithins, and combinations thereof, which are known for use in the preparation of baked products, such as tortillas.

More in particular, the fatty substance may be selected from the group of fatty acid monoglycerides, fatty acid diglycerides, fatty acid triglycerides, waxes, paraffins, sterols, sugar esters of fatty acids, polyglycerol esters, polysorbates, lecithins, succinilated and ethoxylated monoglycerides, stearoyl lactylates, mono- and diacetyl tartaric acid esters of mono- and diglycerides (DATEM's) and fat flours.

Suitable triglyceride oils and fats which may be used include in particular palm fat, palm oil, coconut oil, corn oil, cottonseed oil, canola oil, olive oil, peanut oil, safflower oil, soybean oil, sunflower oil, butter, lard and tallow, and other fats and oils which are suitable for use in food applications, e.g. oils from nuts or fruit seeds. Optionally a fraction of a (vegetable) triglyceride oil is used. A triglyceride oil used as a fatty substance is optionally partially or fully hardened.

The emulsifier fatty substance may in particular be a glyceride or a sugar ester of a fatty acid comprising one or more fatty acid residue chains having 2 carbon atoms or more.

Usually the fatty acid residue chains of a fatty substance used in accordance with the invention have 26 carbon atoms or less, in particular 22 carbon atoms or less. In particular for a low stickiness of the tortillas, it is preferred to use a fatty substance comprising one or more long chain (having more than 12 carbons in the chain) or intermediate long chain fatty acid residues (having 8-12 carbons in the chain).

The fatty substance is preferably applied as a liquid, e.g. liquid oil, or a (fine) powder, crystal, granule or agglomerate, e.g. (fine, free flowing) powdered fat, (fine, free flowing) powdered emulsifier, or (fine, free flowing) powder of fat on a carrier. This facilitates the fatty substance to be distributed evenly over the surface. A free-flowing powdered fatty substance may for instance have been obtained by spray drying or spray cooling.

In particular in case a powdered fatty substance is used, a fatty substance may be selected having a relatively low melting range of 20-40° C. This can be achieved by selecting fatty substances with intermediate long chain fatty acid residues (C8-C12) or fatty substances with high iodine number (which is a measure for the number of double bonds in the fatty acid chain, or in other words a low degree of saturation); both leading to lower melting points.

The oil or free flowing powders may be applied onto the surface of the dough by spraying (oil, or sprayable liquid fats), or by dredging, sprinkling, or scattering.

Usually at least a substantial amount of the free flowing powders has a particle size of less than 3000 nm, preferably less than 1000 nm, more preferably less than 500 nm, more preferably less than 300 nm, more preferable less than 150 nm and most preferably 110 nm. Preferably, the particle size is at least 50 nm. A substantial amount, as used herein in particular means at least 50%, in particular at least 90%, more in particular at least 95%, preferably at least 99% of the particles will pass a sieve with holes of said size.

The term “free-flowing” is used for a powdered material that is not sticky, and thus has no or hardly any tendency to clump or bridge in hoppers.

A solid fatty substance, in particular a solid triglyceride (mixture) may in particular be advantageous for maintaining a low stickiness, also after a prolonged period of storage, compared to a liquid fatty substance, such as a liquid oil.

Usually 10-100% of the surface of the surface is provided with the fatty substance. In particular, at least 20%, at least 40%, at least 50% or at least 75% of the surface may be provided with the fatty substance. This can be achieved by spraying the liquid or powder over the dough piece, after which it is turned around and sprayed again. A good result can be achieved, also without fully covering the surface of the dough, in particular by distributing the fatty substance essentially homogeneously over the surface.

The amount of fatty substance applied to said surface of the dough portion is usually at least 0.0001 g/g dough (0.01 wt. %), in particular at least 0.0005 g/g dough (0.05 wt. %). Preferably the amount is at least 0.001 g/g dough (0.1 wt. %), more preferably at least 0.002 g/g dough (0.2 wt. %) or at least 0.0025 g/gram dough (0.025 wt. %).

The amount of fatty substance applied to said surface of the dough portion is usually 0.01 g/g dough (1 wt. %) or less, in particular 0.005 g/g dough (0.5 wt. %) or less. Such an amount is generally sufficient to improve one or more properties, whereas the increase in fat content in the final product is limited. Thus, the invention allows manufacture of tortillas which can still be classified as low-fat tortillas, starting from low-fat dough.

A high level of fatty substance on the outside of the tortilla may contribute to an extra improvement in the quality of the product. A high level of fat may lead to an increase in blister formation during baking and an improvement in tortilla stacking stickiness (compared to a method of the invention wherein a relatively low amount of fatty substance is used). For one or both of these reasons an amount of 0.0040 g/g dough or less, in particular of 0.0035 g/g dough or less may be preferred. The fatty substance may be applied to the dough piece, before, during or after resting, but in general before shaping (pressing).

The fatty substance may conveniently be applied in any way. In an embodiment, the fatty substance is applied by the providing plates of a press used to shape the dough with the fatty substance and then pressing the dough. With this technique in particular it is easy to apply essentially the whole surface of the tortilla with fatty substance, thus providing optimal coverage of the surface with fatty substance.

Advantageously, the fatty substance is sprayed as a liquid or powder onto the surface of the dough. Spraying is an advantageous technique, because it can easily be done in a continuous preparation process and allows a good distribution of the fatty substance on the surface. Also, this technique is advantage in that the contact-time of the fatty substance with the (heated) pressing plate is kept at a minimum, thereby substantially avoiding degradation of the fatty substance, in case it is heat sensitive. Further, it is easy to avoid contaminating the equipment used for shaping (the press) with fatty substance.

In an embodiment, the fatty substance is applied by placing the dough portions on a surface provided with the fatty substance, for instance a surface on which the dough portions are allowed to rest. This is a preferred way of working when free flowing fat powder or emulsifier powders are used since it will lead to more homogeneous distribution of the fat over the surface, especially when the dough pieces are turned around halfway during resting.

Also, this technique is advantageous in that the contact-time of the fatty substance with the (heated) pressing plate is kept at a minimum, thereby substantially avoiding degradation of the fatty substance, in case it is heat sensitive. Further, it is easy to avoid contaminating the equipment used for shaping (the press) with fatty substance.

The shaping is usually done after having the dough allowed to rest. Shaping is preferably done by pressing the dough portions under a press, e.g. under a hydraulic press. The press is preferably heated to between 100 and 300° C., more preferably to between 150 and 250° C., even more preferably to between 175° C. and 235° C. The skilled person will know to determine a suitable pressure. The press usually exerts 750-1,450 psi (5.2-10 Mpa) of pressure over the plates. Preferably the pressure is 200-3000 psi, more preferably 500-2000 psi, most preferably 750-1450 psi. flattening the ball of dough into the distinctive round, flat tortilla shape. Pressing time (press dwell time) usually is between 0.9 and 1.5 seconds, preferably the pressing time is at least 1.1 sec. Preferably the pressing time is 1.4 sec or less.

Preferably, shaping is conducted after applying the coating ingredients to the surface dough, because the heat transfer during the shaping step may contribute to the salty taste of the tortilla. Shaping is typically done with a heated press. Consequently, the fat on the surface of the tortilla melts during shaping and may spread over the surface of the tortilla more or less homogeneously. It is expected that the other coating ingredients, such as the salty taste enhancers, will spread with the fat in the same homogeneous way. The homogeneous spreading of the fat and other coating ingredients over the tortilla surface is expected to contribute to the beneficial taste sensation of the tortillas obtained with the method of the invention. It is technically also possible to apply the coating ingredients to the surface of the tortilla dough after shaping, but this is very difficult to achieve.

After shaping, the tortilla is baked. This can be done in a manner known per se, e.g. as described above.

The dough may comprise a number of ingredients as described herein below. Typically, the ingredients applied to the surface in the method of the invention (coating ingredients) can be applied in the dough as well (dough ingredients). However, it is noted that when applying ingredients as coating ingredients, the taste is generally perceived as more intense compared to ingredients applied as dough ingredients.

Usually wheat flour is used for preparing the dough.

Dough comprises flour and water, typically in a ratio of about 2:1.

Flour usually comprises gluten and other protein(s) naturally present in the flour. Optionally gluten and/or other protein is added. Usually the protein content (including gluten) is at least about 7.5 wt. %. Usually the protein content (including gluten) is about 14 wt. % or less. Preferably the flour has a protein content of at least 9.5 wt. %, in particular a protein content of 9.5-11.5 wt. %. With conventionally prepared tortillas problems have been encountered with flour containing less protein or gluten yield tortillas that crack easily and split after overnight storage. Flours with more than 11.5 wt. % gluten, however, produce doughs that take longer to mix and that require longer resting periods before pressing and baking. It is contemplated that in a method according to the invention, these drawbacks may be alleviated at least to some extent.

The dough may further comprise sodium chloride, even though the amount of sodium chloride in the dough should be kept low according to the invention. For example, sodium chloride may be required to obtain a proper dough consistency. Furthermore, at least a certain amount of sodium chloride may be desirable to obtain a sufficient salty taste. The dough may comprise less than 1.5 wt., preferably less than 1.0 wt. %, most preferably less than 0.7 wt. % sodium chloride, based on flour weight.

An emulsifier (usually 0.3-0.8 wt. %, if present) can be present in the dough, for instance sodium-stearoyl-lactate (SSL). An emulsifier can be used to condition the dough, making it easier to handle and improving the finished texture. Mono- and diglycerides (e.g. distilled) can help to reduce shortening levels, in order to achieve a similar shortening effect. These can be used to improve tearing quality and help prevent tortillas from sticking to each other in the package. A monoglyceride may be used to provide anti-staling qualities and improve shelf life. Up to 44% improvement in shelf life has been found possible upon using the co-blended product.

A leavening agent can be present, providing puffing during the baking process, yielding a tender tortilla. Baking powder and leavening acids such as monocalcium phosphate (MCP), sodium aluminium phosphate (SALP) and sodium aluminium sulphate (SAS), sodium acid pyrophosphate (SAPP) may be used .Yeast may be used to provide the typical yeasty aroma and taste, as well as for leavening.

The dough may further comprise sodium salts. Although sodium salt when applied as a coating ingredient will provide the tortilla with a stronger salt taste than when applied as an ingredient in the dough (dough ingredient), the presence of salt in the dough may be desirable. The ingredient salt (which is the salt applied as a dough ingredient) is typically present in the dough in an amount of 0.7-1.3 wt. % based on the dough weight, such as for example around 1% ingredient salt, the total amount will be less than 1.1 wt. % sodium chloride based on the total weight of the dough (dough weight). This is a significant decrease versus the currently used 1.8-2.0 wt. % sodium chloride. Compared to this large amount, the amount of various sodium salts that are typically added in small amounts to provide the tortilla with additional benefits, such as for example baking powders, do not significantly contribute to the sodium content of the tortilla.

One or more enzymes belonging to the group of amylases, xylanases, proteases, lipases and oxidases, can be added. The enzymes may contribute to one or more desirable effects. Amylases have a positive effect on rollability and foldability, proteases have a positive effect on diameter and stack height. Xylanases and lipases have a positive effect on dough characteristics and on whiteness of the tortillas. In conventional tortillas, enzymes can have a negative effect on tortilla stickiness when used in suboptimal dosages or in suboptimal combinations. The present invention is also useful to improve (reduce) tortilla stickiness, as a result of an adverse affect of an enzyme or combination of enzymes.

A gum such as guar, carboxymethylcellulose, xanthan or gum arabic can be used to improve machinability, decrease dough stickiness, delay staling, improve rolling and folding properties, bind water, improve freeze/thaw stability and decrease moisture loss. It is advised to add gum (usually 0.1-0.5 wt. %, if present) during dry-blending to assure a homogeneous mix.

Starch can also add functionality to tortilla dough. Co-blending unmodified pregelatinized starches, such as potato starch, waxy starch, high amylose starch (usually 5-15% based on flour weight, if present) with monoglyceride can improve machinability of a tortilla dough, thus improving production capacity.

A reducing agent can be used to improve dough quality and reduce resting time. L-cysteine, sodium bisulphite or sodium metabisulphite (usually 10-40 ppm, if present) may be used improve machinability and decrease elasticity. The reducing agents comprising sodium are typically added in such low amounts that they do not make a significant contribution to the sodium salt level in the tortilla. An oxidizing agent such as ascorbic acid, azodicarbonamide or calcium peroxide may be used to improve mixing tolerance and dough machinability.

Milk solids can be added, such as non-fat dry milk. Such ingredient can improve crumb colour, flavour or dough handling. A concentration of about 0.75 wt. % milk solids is recommended.

A preservative can be added (usually 0.1-0.75 wt. %, if present), to inhibit mould growth after packaging. Calcium propionate, organic propionates, potassium sorbates, sorbic acid are in particular suitable as tortilla preservatives.

If desired, a pH-regulator, typically an acid such as fumaric, adipic, citric, is added to control the final pH of the tortilla, which is preferably 5.5 to 6.5 at 25° C.). pH can be determined by measuring the pH directly in the dough using a pH electrode. Alternatively, the pH in the final product can be determined by homogenizing a tortilla piece with fixed weight in water and measuring the pH using a glass electrode coupled with a pH meter. A pH below this range may result in a lighter colour, while a pH above the range may result in a darker colour, a bitter taste, more browning, a soapy mouthfeel or a limited mould free shelf life.

In principle, a method of the invention can be used to prepare any type of flour tortilla. The tortilla may be selected from no-fat tortilla's, reduced fat tortilla's, low-fat tortilla's and full-fat tortilla, either with a reduced or normal sodium salt content.

Full-fat tortillas usually have an ingredient-fat content of 5-20 wt. %, in particular of 6-20 wt. %, more in particular 8-20 wt. %

The method of the invention can be used for preparing regular-fat tortillas, made from dough having a fat content of about 8-12 wt. % (regular tortilla) or for tortillas, made from dough comprising less than 6 wt. % fat (reduced-fat tortillas), before applying the coating composition. The fat content, as used herein is the fat content based on flour weight, unless specified otherwise. The invention is in particular advantageous with respect to providing a reduced-fat tortilla. The fat used when preparing the dough (i.e. mixed with the other ingredients from which the dough is made) may also be referred to as “ingredient fat” to distinguish it from the fatty substance used as a coating ingredient applied to the surface of the dough.

The ingredient fat content of the dough for a low-fat tortilla (as defined by the United States 21 CFR 101.62, 101.13 (1) (m)) may in particular be less than 6 wt. % on flour weight or less than 3 g per serving of a 55 g tortilla. Preferably, the fat content is of about 3 wt. % or less. More preferably the fat content is 2.5 wt. % or less. In a specific embodiment, the fat content is 2.0 wt. % or less.

Usually ingredient fat is present in the form of shortening (triglycerides, essentially solid at 20° C.). This improves machinability and reduces dough stickiness. High shortening levels also help prevent cracking when the tortilla is folded or rolled. Lard and partially hydrogenated vegetable fats tend to make tortillas hard. Blending liquid oil with lard, other shortenings or partially hydrogenated liquid vegetable oils helps plasticize the tortilla. 100% vegetable oil (oil being defined as liquid at room temperature) is rarely used in conventional flour tortilla production due to excessive stack stickiness. But there is large interest from producers to use liquid oil; mainly with regards to trans-free requirements, costs, lack of clogging and absence of the need for heating the fat before usage. Thus, the present invention offers an additional advantage in that a substantial part or all of the shortening may be replaced by vegetable oil, whilst obtaining tortillas with an acceptably low stack stickiness.

The present invention is further directed to a flour tortilla that is obtainable by the method of the invention.

According to the invention, the salty taste enhancer is mainly embedded on the surface of the flour tortilla.

A flour tortilla of the invention has an inhomogeneous distribution of salty taste enhancer throughout the tortilla. The outer layer of a tortilla obtained by the method of the invention will have a higher salt content than the average salt content in the tortilla. In case the salty taste enhancer is not sodium chloride, the content of salty taste enhancer at the surface of the tortilla is higher than the average content of salty taste enhancer in the tortilla. In case the salty taste enhancer is also applied as a dough ingredient, such as for example in the case of sodium chloride, the ratio of salty taste enhancer content of the outer 10 vol. % of the tortilla to average salty taste enhancer content of the tortilla is at least 1:1, preferably at least 3:2, more preferably at least 3:1, even more preferably at least 5:1, even more preferably at least 10:1, even more preferably at least 15:1, most preferably at least 20:1.

The core of the tortilla may be essentially free of salty taste enhancer.

The flour tortilla of the invention may be essentially free of added sodium chloride at the surface of the tortilla. This has the advantage that the sodium content of the flour tortilla is as low as possible, which is good for the health of the consumer. Thus, the flour tortilla may comprise substantially no sodium chloride.

Alternatively, the flour tortilla may comprise sodium chloride at its surface. In this case, the flour tortilla of the invention may have a sodium chloride content (weight per volume) at the surface of the tortilla which is significantly higher than the average sodium chloride content (weight per volume) of the tortilla. As described above, it was found that sodium chloride at the surface has a stronger salty taste than sodium chloride present in the baked dough of the tortilla.

As described hereinabove, the flour tortilla of the invention may comprise sodium chloride, either in its core, at its surface or both. In this case, the flour tortilla of the invention may have a sodium chloride content less than 1.5 wt %, preferably less than 1.3 wt. %, more preferably less than 1.2 wt. %, most preferably less than 1 wt. %, even more preferably less than 0.7 wt. % based on the total weight of flour present in the flour tortilla.

Most large commercial tortilla manufacturers use the hot-press method of mixing, forming and baking to produce flour tortillas, e.g. as described in Bello, A. B.; Serna-Saldivar, S. O.; Waniska, R. D. and Rooney, L. W. Methods to prepare and evaluate wheat tortillas, Cereal Foods World (1991). A suitable method for preparing low fat flour tortillas has been described in WO 2009/041821.

In this method, a smooth dough comprising flour, water, fat, salt, and usually one or more ingredients selected from baking powder, yeast, preservatives, gums, reducing agents and emulsifiers is mixed to an extensible, elastic, non-sticky and relatively firm dough.

By optimally mixing and adding proper water levels a silky, smooth-textured dough, with many layers in the final product is formed.

Dough temperature also affects consistency, with lower dough temperatures increasing water absorption. This leads to a softer final product. The temperature may for instance be in the range of 27-38 ° C. The optimum temperature for flour-tortilla dough is usually 27° to 33.5° C.

After mixing, the tortilla dough is scaled to a desired weight, usually from about 30 to about 150 gram, e.g. about 40 to about 50 gram or about 45 to about 48 gram, depending on the desired diameter for the tortilla, is rounded into a ball and is then allowed to rest (relax, proof), usually for about 5-15 minutes. Proofing the dough helps the pressing process. Insufficient relaxation can result in a translucent finished product with less layering.

After resting, the dough pieces are placed under a hydraulic press that is heated. The pressing process forms a thin skin on the surface of the tortilla, limiting the escape of steam and carbon dioxide during baking. This causes the tortilla initially to form small blisters or gas pockets which deflate upon cooling.

Baking is usually done in a conveyer oven that flips the tortilla over during its journey through the oven. In particular, a specialized direct gas fired slatted belt may be used. Baking time (oven dwell time) may for instance be approximately 30 seconds in a 190° to 235° C. oven. In a specific embodiment, the oven temperature is 190-200 ° C. The tortillas are then cooled and packaged.

The over-all quality of tortillas, is determined by various properties. In particular tortillas having a reduced fat content may be considered inferior to regular-fat tortillas (typically containing about 8 -12 wt. % fat, for instance 8-9 wt. % fat), but also for regular-fat tortillas it is desirable to improve one or more properties.

Relevant properties in particular include:

Folding: a low tendency to break on the seams upon folding the tortilla is desired.

Breaking: it is desired that the tortilla shows good resistance against tearing. E.g. low-fat tortillas tend to be torn apart at a lower tearing force than regular tortillas.

Rolling: a good tortilla should be easily rollable, e.g. around a known diameter dowel, rod or stick, without showing substantial cracking and/or breaking. This is especially a challenge upon aging of the tortillas. Thus, it would be desirable to provide a tortilla that has good rolling properties. In particular it is desired to provide a tortilla with good rolling properties for a prolonged period of time.

Springiness: Upon taking a low fat full tortilla in one hand and crumpling or wadding it firmly, it is desirable that the tortilla ‘springs back’ freely and unfolds completely without breaking.

Colour: a product with a substantially uniform (off-)white colour, wherein blisters are present is appreciated by many consumers. The blisters show up as lightly browned spots on the surface. In particular, low-fat tortillas have a less off-white, more pale and less uniform colour.

Layering/lamination: a layered structure of the tortilla is desired. In particular, low-fat tortillas tend to be less layered compared to regular tortillas.

Dryness: a tortilla should preferably have a not too dry mouthfeel Consumers recognize reduced fat and low fat tortillas as having a drier mouthfeel than traditional full fat tortillas.

Size: The size (diameter) of conventional reduced fat tortillas is significantly smaller than the size of regular-fat tortillas, of the same weight. Low-fat tortillas of a specific weight may for instance have a diameter that is less than 90% of the diameter of a regular-fat tortilla of the same weight and apart from the fat having the same composition

Uniformity size/shape: Reduced fat tortillas tend to be less uniform in shape and size.

Stacking stickiness: It is desired that—when stacked and packaged—tortillas show no or a low tendency to stick to one another. In particular, upon aging the tendency to stick may increase. In particular, tortillas known in the art, made with vegetable oil instead of solid shortening tend to stick more to each other upon prolonged shelf life. Also tortillas, known in the art, made with enzymes, such as bacterial or fungal amylases, tend to stick more to each other, regardless of shelf life.

Stack height: As a consequence of smaller diameters, the height of a stack of, e.g., 10 tortillas is generally higher for reduced fat tortillas than for regular fat tortillas; i.e. low fat tortillas are thicker than regular tortillas. This is unwanted due to negative effects on rollability, foldability and eating characteristics.

Opacity: Opacity is measured subjectively using a continuous scale. 100% is completely opaque (white) and 0% is completely translucent (not white). Ideally, translucency is eliminated since opacity is a desired quality attribute.

The invention is further directed to the use of a flavoring to improve the taste of the flavoring in the tortilla by applying the flavoring to at least part of the surface of a tortilla dough prior to baking. The flavoring may be sodium chloride. The flavoring may further be a salty taste enhancer as defined above.

The invention is illustrated by the following example.

### EXAMPLE

Flour tortillas were baked using similar preparation methods, which differed in amounts of sodium chloride and salty taste enhancer used. Two types of salty taste enhancer were used, viz. Soda-Lo 20 and Soda-Lo 30 (two sodium salt compositions having enhanced salty taste) and autolyzed yeast (a sodium salt substitute).

Flour Tortillas were prepared according to the following recipe and preparation method

| | | wt. % |
|---|---|---|
| Ingredients | Parts by weight | (based on flour) |
| Flour | 1000 | 100 |
| Water | 540 | 54 |
| Shortening | 90/20* | 9/2* |
| NaCl/Salty Taste Enhancer | varies | Varies |
| Baking powder: 2403 FY | 20 | 2 |
| Fumaric acid | 3 | 0.3 |
| Sorbic acid | 3 | 0.3 |
| Calcium propionate | 5 | 0.5 |
| SSL | 2.5 | 0.25 |
| L-cysteine | 0.02 | 0.002 |

*90 parts for regular-fat tortilla; 20 parts for low-fat tortilla

Baking powder 2403 FY is a product from Fleischmann (USA) and contains: <40 wt % disodium pyrophosphate; <10 wt % calcium dihydrogen phosphate; <40 wt % sodium hydrogen carbonate.

The salty taste enhancers Soda-Lo 20 and Soda-Lo 30 are available from the company Eminate. The autolyzed yeast used was high glutamate autolyzed yeast and is available under the name High 5 available from AB Mauri.

Processing
Mixing 2 min. slow 5 min. high speed with a McDuffy mixer.
Dough temperature: 30° C.
Dough weight: 1500 g.
Resting time: 2 min.
Dividing/shaping: Automatic dividing/round up in 30 dough pieces of 50 g each with a W&P Rotomat GS50
Resting time : 5 min. at room temp. on clothed plate.
Lawrence Equipment semi automatic tortilla machine.
Dwell time: 1,2 sec
Dwell temp.: 400° F. and 415° F. bottom/top
Baking temp.: between 400° F.-415° F. , two top burners on
Baking time ca.: ca 25 sec.
Cooling: Ca. half an hour.
Wrap: 10 pieces in a bag.

Dough tortillas were baked according to the method above, using different salt and salt substitute content in the dough and the coating composition, as shown in Table 1. Samples A1, A2, B1, C1 and D1 were prepared using a preparation method known from the prior art and were used a reference. Samples B2, B3, C2, C3, D2 and D3 were prepared according to a method of the invention.

It was found that flour tortillas prepared by a method wherein salt or salt substitute was present in the coating composition (A2, B2, B3, C2, C3, D2, D3) were perceived as more salty than flour tortillas prepared by a method wherein salt or salt substitute was only present in the dough.

It was found that using autolyzed yeast in the coating composition significantly enhanced the salty notes initial impact and extended the duration of salty sensation.

1. Method for preparing a flour tortilla comprising:
(i) providing a flour tortilla dough in a portion sufficient to prepare the tortilla;
(ii) coating at least part of the surface of the dough with a salty taste enhancer, thus obtaining a coated dough; thereafter
(iii) forming the coated dough into a tortilla shape; and thereafter
(iv) baking the coated dough;
wherein the salty taste enhancer is a sodium salt substitute, or
wherein the salty taste enhancer is a sodium salt composition having enhanced salty taste, or
wherein the salty taste enhancer is a chloride salt of sodium or potassium, which chloride salt is applied in an amount of at least 0.05 wt. % based on flour weight.

2. Method according to claim 1 wherein the salty taste enhancer is selected from the group consisting of autolyzed yeast, yeast extract, dried yeast, hydrolyzed yeast, inactivated yeast, glutamate, micronized sodium chloride.

3. Method according to claim 1, wherein the at least part of the surface of the dough is further coated with a fatty substance.

4. Method according to claim 1. wherein the at least part of the surface of the dough is further coated with an ammonium salt.

5. Method according to claim 1, wherein at least part of the surface of the dough is further coated with a food acid.

6. Method according to claim 1, wherein the flour tortilla dough has a sodium content less than 1.5 wt. %, preferably less than 1.3 wt. %, even more preferably less than 0.7 wt. %, based on the total weight of the dough.

7. Method according to claim 1, wherein the coated dough has a sodium chloride content less than 1.3 wt. %, preferably less than 1 wt. %, based on flour weight.

8. Method according to claim 1, wherein at least part of the surface of the dough with 0.2-1.0 wt %, more preferably 0.4-0.7 wt. %, sodium chloride, based on flour weight.

9. Method according to claim 1, wherein the at least part of the surface of the dough is coated with a salty taste enhancer in an amount of 0.05-1 wt. %, preferably 0.1-0.7, more preferably 0.2-0.4 wt. % based on flour weight.

10. Flour tortilla obtainable by a method according to claim 1.

11. Use of a flavoring to improve the taste of the flavoring in the tortilla by applying the flavoring to at least part of the surface of a tortilla dough prior to baking, wherein the flavoring is selected from the group of sodium chloride, autolyzed yeast, yeast extract, dried yeast, hydrolyzed yeast, inactivated yeast, glutamate and micronized sodium chloride.
